(19) United States
(12) Patent Application Publication
(10) Pub. No.: US 2025/0174830 A1
(43) Pub. Date: May 29, 2025

(54) WASHED SULFUR IMPREGNATED 3D CARBONIZED CARBON NANOFIBER FOAM (SCCNF-F-AW) FOR LITHIUM SULFUR BATTERY AND PROCESS FOR PREPARATION THEREOF

(71) Applicant: COUNCIL OF SCIENTIFIC AND INDUSTRIAL RESEARCH AN INDIAN REGISTERED BODY INCORPORATED UNDER THE REGN., New Delhi (IN)

(72) Inventors: Manjusha Vilas SHELKE, Pune (IN); Thripuranthaka MARULASIDDAPPA, Pune (IN); Vikash CHATURVEDI, Pune (IN)

(21) Appl. No.: 18/725,711

(22) PCT Filed: Dec. 15, 2022
(86) PCT No.: PCT/IN2022/051078

§ 371 Date: Jun. 28, 2024

(30) Foreign Application Priority Data
Dec. 29, 2021 (IN) 202111061662

(51) Int. Cl. H01M 50/449; H01M 4/02; H01M 4/133; H01M 4/583; H01M 10/052; H01M 50/403; H01M 50/431

(52) U.S. Cl. CPC H01M 50/449; H01M 4/133; H01M 4/583; H01M 10/052; H01M 50/403; H01M 50/431; H01M 2004/021; H01M 2004/028

(57) ABSTRACT

The present disclosure provides a washed sulfur impregnated 3D carbonized carbon nanofiber foam (SCCNF-f-AW) for lithium-sulfur battery and a method of preparation thereof. The washed sulfur impregnated 3D carbonized carbon nanofiber foam (SCCNF-f-AW) acts as an electrode, exhibiting high sulfur loading and stability; improving the energy storage capacity and life cycle of lithium-sulfur batteries.

### TECHNICAL FIELD OF THE INVENTION

The present disclosure relates generally to the field of lithium-sulfur battery. Particularly, the present disclosure provides a washed sulfur impregnated 3D carbonized carbon nanofiber foam (SCCNF-f-AW) for lithium sulfur battery. The present disclosure also relates to a method of preparation of said SCCNF-f-AW.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Lithium-sulfur (Li—S) batteries have emerged as a promising next-generation energy storage system, owing to a substantially high theoretical specific capacity of ˜1675 mAhg⁻¹ and energy density of ˜2600 Whkg⁻¹, which is approximately 3 to 5 times higher than commercially available conventional Li-ion batteries. However, insulating nature of sulfur (5×10⁻³⁰ S cm⁻¹ at 25° C.), significant volume expansion during lithiation (˜79%), and shuttling of polysulfide [Li₂Sₓ (3<x≤8)] species severely hinders the cycle performance of the battery; resulting in capacity fade and cycling instability. This reduces the utilization of sulfur as active material in the electrode that impedes the practical application of Li—S batteries.

The shuttle effect has been addressed in the art by applying several strategies, such as using different types of carbon materials, polar binding additives, and separator modifications (Fang R, Zhao S, Sun Z, Wang D W, Cheng H M and Li F 2017, Adv. Mater. 29 1606823). Further, various carbon-based materials (hosts) have been utilized, cither as the sulfur-impregnated positive electrode in Li—S batteries or to trap polysulfides species for the Li—S batteries. However, these carbon-based conductive materials of Li—S batteries suffer from certain drawbacks such as defective electrode surface, limited energy density, and low sulfur loading capacity, stability and resulting in Li—S batteries with short life cycle.

In view of above-stated shortcomings, there exists a need in the art for a sulfur impregnated carbon-based electrode material for a Li—S battery and a method of preparation thereof that may overcome one or more drawbacks associated with the conventional carbon-based electrode materials of Li—S batteries and methods of preparation thereof.

### OBJECTIVES OF THE INVENTION

An object of the present disclosure is to overcome one or more drawbacks associated with the conventional carbon-based electrode material of Li—S battery and methods of preparation thereof.

Another object of the present disclosure is to provide a washed sulfur impregnated 3D carbonized carbon nanofiber foam (SCCNF-f-AW) for Li—S battery.

Another object of the present disclosure is to provide washed sulfur impregnated 3D carbonized carbon nanofiber foam (SCCNF-f-AW) that acts as a cathode in Li—S battery.

Another object of the present disclosure is to provide washed sulfur impregnated 3D carbonized carbon nanofiber foam (SCCNF-f-AW) that is stable and gives a long life to Li—S batteries.

Another object of the present disclosure is to provide a method of preparation of a washed sulfur impregnated 3D carbonized carbon nanofiber foam (SCCNF-f-AW) for a Li—S battery that is easy and economical.

Still another object of the present disclosure is to provide a Li—S cell comprising said sulfur impregnated 3D carbonized carbon nanofiber foam (SCCNF-f-AW) as a cathode.

### SUMMARY OF THE INVENTION

The present disclosure relates to the field of Li—S battery. Particularly, the present disclosure provides a washed sulfur impregnated 3D carbonized carbon nanofiber foam (SCCNF-f-AW) for Li—S battery. The present disclosure also relates to a method of preparation of said SCCNF-f-AW.

An aspect of the present disclosure relates to a composite comprising a washed sulfur impregnated 3D carbonized carbon nanofiber foam (SCCNF-f-AW) for lithium-sulfur battery having surface area ranging from 20 m²g⁻1 to 25 m²g⁻1 and pore size ranging from 2 nm to 5 nm.

In an embodiment, the washed sulfur impregnated 3D carbonized carbon nanofiber foam (SCCNF-f-AW) has surface area of 23 m²g⁻¹ and pores size ranging from 2 nm to 5 nm.

Another aspect of the present disclosure relates to a process for preparation of a washed sulfur impregnated 3D carbonized carbon nanofiber foam (SCCNF-f-AW) for lithium-sulfur battery, the process comprising the steps of:
(i) taking a carbon nanofiber powder (CNF) and refluxing it with HNO₃ to obtain a carbon nanofiber (CNF) powder;
(ii) washing the carbon nanofiber (CNF) powder obtained in step (i) with de-ionized water and ethanol and dried to obtain a functionalized carbon nanofiber powder (f-CNF)
(iii) dispersing the functionalized carbon nanofiber powder in de-ionized water in a ratio ranging from 4:1 to 6:1 and subjected to ultrasonication for dispersion;
(iv) adding glutaraldehyde, resorcinol, and sodium tetraborate decahydrate to the above obtained ultrasonicated mixture of step (iii);
(v) subjecting the mixture obtained in step (iv) to freezing and drying to obtain a 3D carbon nanofiber foam (CNF-f);
(vi) subjecting the 3D carbon nanofiber foam (CNF-f) to a thermal treatment to obtain a 3D carbonized carbon nanofiber foam (CCNF-f);
(vii) impregnating the 3D carbonized carbon nanofiber foam (CCNF-f) obtained in step (vi) with sulfur by heating the CCNF-f with an elemental sulfur powder to obtain a sulfur impregnated 3D carbonized carbon nanofiber foam (SCCNF-f); and
(viii) subjecting the sulfur impregnated 3D carbonized carbon nanofiber foam (SCCNF-f) obtained in step (vii) to washing with a solvent to remove excess sulfur to obtain the washed sulfur impregnated 3D carbonized carbon nanofiber foam (SCCNF-f-AW).

In an embodiment, the carbon nanofiber (CNF) is refluxed with HNO₃ in step (i) at a temperature ranging from 50° C. to 70° C. for a time period ranging from 4 hr to 10 hr. In an embodiment, the carbon nanofiber powder (CNF) is dispersed in distilled water in step (iii) in a ratio of 5:1. In an embodiment, the 3D carbon nanofiber foam (CNF-f) in step (vi) is subjected to thermal treatment at a temperature from 700° C. to 900° C. In an embodiment, the 3D carbon nanofiber foam (CNF-f) in step (vi) is subjected to thermal treatment at a temperature of 800° C. In an embodiment, the impregnation in step (vii) is performed at a temperature ranging from 160° C. to 220° C. for a time period ranging from 1 hr to 3 hrs. In an embodiment, the solvent is selected from any or a combination of toluene, chlorobenzene, toluene, p-xylene, and cyclohexane.

Still another aspect of the present disclosure relates to a lithium-sulfur cell comprising:
(i) a cathode comprising a washed sulfur impregnated 3D carbonized carbon nanofiber foam (SCCNF-f-AW);
(ii) an anode;
(iii) a separator; and
(iv) an electrolyte.

In an embodiment, the separator comprises a coating of functionalized multi-walled carbon nanotube (f-MWCNT).

In an embodiment, the washed sulfur impregnated 3D carbonized carbon nanofiber foam (SCCNF-f-AW) exhibits sulfur loading ranging from 1.2 mgcm⁻² to 1.8 mgcm⁻².

### BRIEF DESCRIPTION OF THE DRAWINGS OF THE INVENTION

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1(a) and FIG. 1(b) illustrates an exemplary snippet depicting powder X-ray diffraction (p-XRD) patterns of 3D carbonized CNF Foam (CCNF-f) and sulfur impregnated 3D carbonized CNF foam (SCCNF-f-AW) respectively, in accordance with the embodiments of the present disclosure.

FIG. 2(a) and FIG. 2(b) illustrates an exemplary snippet depicting Raman spectra of CCNF-f and SCCNF-f-AW respectively, in accordance with the embodiments of the present disclosure.

FIG. 3 illustrates an exemplary snippet depicting pore size distribution for CCNF-f) and SCCNF-f-AW using non-local density functional theory (NLDFT), in accordance with the embodiments of the present disclosure.

FIG. 4 illustrates an exemplary snippet depicting BET N2 adsorption-desorption isotherm of CCNF-f and SCCNF-f-AW, in accordance with the embodiments of the present disclosure.

FIG. 5(a) through FIG. 5(f) illustrates an exemplary snippet depicting survey spectra for CCNF-f and SCCNF-f-AW, in accordance with the embodiments of the present disclosure.

FIG. 6(a) through FIG. 6(h) illustrates an exemplary snippet depicting

Scanning electron micrographs for CCNF-f and SCCNF-f-AW, in accordance with the embodiments of the present disclosure.

FIG. 7(a) and FIG. 7(b) illustrates an exemplary snippet depicting 3D volume rendered X-ray tomography of CCNF-f and SCCNF-f-AW respectively, in accordance with the embodiments of the present disclosure.

FIG. 8(a) and FIG. 8(b) illustrates an exemplary snippet depicting pore size distribution obtained from tomography analysis for CNF-f and CCNF-f respectively, in accordance with the embodiments of the present disclosure.

FIG. 9(a) and FIG. 9(b) illustrates an exemplary snippet depicting segmented 3D X-ray tomography of CNF-f and CCNF-f respectively, in accordance with the embodiments of the present disclosure.

FIG. 10 illustrates an exemplary snippet depicting 3D visualization of pores in CCNF-f, in accordance with the embodiments of the present disclosure.

FIG. 11 illustrates exemplary snippets depicting (a) Cyclic voltammogram (CV) at a scan rate of 0.1 mV s⁻¹, (b) Electrochemical impedance spectra before and after the CV measurement, (c) cycling stability at a current density of 100 mAg⁻¹ and (d) specific capacity versus potential graph for the sample SCCNF-f-AW, in accordance with the embodiments of the present disclosure.

FIG. 12 illustrates exemplary snippets depicting (a) Cyclic voltammogram (CV) at a scan rate of 0.05 mVs⁻¹, (b) Electrochemical impedance spectra before and after the CV measurement, (c) cycling stability at a current density of 100 mAg⁻¹ and (d) specific capacity versus potential plot for the for the sample SCCNF-f-AW-CNT, in accordance with the embodiments of the present disclosure.

FIG. 13 illustrates a general schematic of the Li—S cell in accordance with the embodiments of the present invention.

### DETAILED DESCRIPTION OF THE INVENTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

The embodiments herein and the various features and advantageous details thereof are explained more comprehensively with reference to the non-limiting embodiments that are detailed in the following description. Descriptions of well-known components and processing techniques are omitted so as to not unnecessarily obscure the embodiments herein. The examples used herein are intended merely to facilitate an understanding of the ways in which the embodiments herein may be practiced and to further enable those of skill in the art to practice the embodiments herein. Accordingly, the examples should not be construed as limiting the scope of the embodiments herein.

Unless otherwise specified, all terms used in disclosing the invention, including technical and scientific terms, have the meaning as commonly understood by one of ordinary skill in the art to which this invention belongs. By means of further guidance, term definitions may be included to better appreciate the teaching of the present invention.

As used in the description herein, the meaning of “a,” “an,” and “the” includes plural reference unless the context clearly dictates otherwise. Also, as used in the description herein, the meaning of “in” includes “in” and “on” unless the context clearly dictates otherwise.

As used herein, the terms “comprise”, “comprises”, “comprising”, “include”, “includes”, and “including” are meant to be non-limiting, i.e., other steps and other ingredients which do not affect the end of result can be added. The above terms encompass the terms “consisting of” and “consisting essentially of”.

In some embodiments, the numerical parameters set forth in the written description are approximations that can vary depending upon the desired properties/conditions sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it were individually recited herein.

The headings and abstract of the invention provided herein are for convenience only and do not interpret the scope or meaning of the embodiments.

The present disclosure relates to the field of lithium-sulfur battery. Particularly, the present disclosure provides a washed sulfur impregnated 3D carbonized carbon nanofiber foam (SCCNF-f-AW) for lithium-sulfur battery. The present disclosure also relates to a method of preparation of said SCCNF-f-AW. The lithium-sulfur battery prepared by using said SCCNF-f-AW exhibits high sulfur loading capacity, stability and long lifecycle.

An aspect of the present disclosure relates to a composite comprising a washed sulfur impregnated 3D carbonized carbon nanofiber foam (SCCNF-f-AW) for lithium-sulfur battery, having a surface area ranging from 20 m²g⁻¹ to 25 m²g⁻¹ and pore size ranging from 2 nm to 5 nm. In an embodiment, the washed sulfur impregnated 3D carbonized carbon nanofiber foam (SCCNF-f-AW) has a surface area of 23 m²g⁻¹ and pores size ranging from 2 nm to 5 nm.

In optional embodiment, the composite comprising 3D carbonized carbon nanofiber foam (CNF) for lithium-sulfur battery, having a surface area ranging from 280 m²g⁻¹ to 350 m²g⁻¹ and pore size below 7 μm. Preferably, the 3D carbonized carbon nanofiber foam (CCNF-f) has a surface area of 310 m²g⁻¹ and pores size below 7 μm. More preferably, the composite has pores size ranging from 2 nm to 7 um, or pores size ranging from 14 nm to 7 μm or furthermore preferably pores size ranging from as low as 2 nm to 14 nm to as high as 1 to 7 μm (the CCNF has bimodal porosity i.e., micropores ranging from 2-14 nm and micropores ranging from 1-7 μm).

An aspect of the present disclosure relates to a process for preparation of a washed sulfur impregnated 3D carbonized carbon nanofiber foam (SCCNF-f-AW) for lithium-sulfur battery, the process comprising the steps of: (i) taking a carbon nanofiber (CNF) and refluxing it with HNO₃ to obtain a carbon nanofiber (CNF) powder; (ii) washing the carbon nanofiber (CNF) powder obtained in step (i) with ethanol and dried to obtain a carbon nanofiber foam (CNF-f); (iii) dispersing the carbon nanofiber foam (CNF-f) in de-ionized water in a ratio ranging from 4:1 to 6:1 and subjected to ultra-sonication for dispersion; (iv) adding glutaraldehyde, resorcinol, and sodium tetraborate decahydrate to the above obtained ultra-sonicated mixture of step (iii); (v) subjecting the mixture obtained in step (iv) to freezing and drying to obtain a 3D carbon nanofiber foam (CNF-f); (vi) subjecting the 3D carbon nanofiber foam (CNF-f) to a thermal treatment to obtain a 3D carbonized carbon nanofiber foam (CCNF-f); (vii) impregnating the 3D carbonized carbon nanofiber foam (CCNF-f) obtained in step (vi) with sulfur by heating the CCNF-f with an elemental sulfur powder to obtain a sulfur impregnated 3D carbonized carbon nanofiber foam (SCCNF-f); and (viii) subjecting the sulfur impregnated 3D carbonized carbon nanofiber foam (SCCNF-f) obtained in step (vii) to washing with a solvent to remove excess sulfur to obtain the washed sulfur impregnated 3D carbonized carbon nanofiber foam (SCCNF-f-AW).

In an embodiment, the carbon nanofiber (CNF) is reflux with HNO₃ in step (i) at a temperature ranging from 50° C. to 70° C. for a time period ranging from 4 hr to 10 hrs. In an embodiment, refluxed carbon nanofiber (CNF) powder is initially washed with distilled water until the pH is neutral, before washing with ethanol. In an embodiment, the carbon nanofiber (CNF) powder obtained in step (i) is washed with water and ethanol. Utilizing carbon nanofiber as a starting material offer an advantage that they can be functionalizing even at low temperature (50° C. to 70° C.), when subjected to reflux with HNO₃.

In an embodiment, the carbon nanofiber foam (CNF-f) is dispersed in de-ionized water in step (iii) in a ratio of 5:1. In an embodiment, in step (iv) after the addition of each of glutaraldehyde, resorcinol, and sodium tetraborate decahydrate, the dispersion was subjected to ultrasonication.

In an embodiment, the mixture obtained in step (iv) is subjected to drying by any conventional method known to be appreciated by a person skilled in the art to serve the intended purpose. In an embodiment, drying is performed by vacuum drying.

In an embodiment, the 3D carbon nanofiber foam (CNF-f) in step (vi) is subjected to thermal treatment at a temperature from 700° C. to 900° C. In an embodiment, the 3D carbon nanofiber foam (CNF-f) in step (vi) is subjected to thermal treatment at a temperature of 800° C. In an embodiment, thermal treatment is subjected under an inert atmosphere. Upon thermal treatment, the 3D carbon nanofiber foam (CNF-f) having cross-linking gel like structure is transformed into a 3D carbonized carbon nanofiber foam (CCNF-f) having conducting framework without compromising their structure. This enhances the performance of the lithium-sulfur battery by improving their electrical conductivity. Thermally treating the 3D carbon nanofiber foam (CNF-f) below the above temperature range results in retention of cross-linking gel-like structure, and heating beyond the above temperature range leads to the collapse of the foam structure.

In an embodiment, the impregnation in step (vii) is performed at a temperature ranging from 160° C. to 250° C. for a time period ranging from 1 hr to 3 hrs. In an embodiment, the impregnation in step (vii) is performed at a temperature ranging from 160° C. to 250° C. for 2 hrs under inert atmosphere followed by cooling to obtain the sulfur impregnated 3D carbonized carbon nanofiber foam (SCCNF-f). In an embodiment, the impregnation in step (vii) is performed at a temperature of 220° C. In an embodiment, the impregnation in step (vii) is performed for a time period of 2 hr. In an embodiment, the solvent is selected from any or a combination of toluene, chlorobenzene, toluene, p-xylene, and cyclohexane. Washing of the sulfur impregnated 3D carbonized carbon nanofiber foam (SCCNF) with a suitable solvent (having an affinity for sulfur and inert toward the carbon nanofiber foam) removes excess sulfur (which reduces the dissolution of excess sulfur and prevent formation of an insulating layer on the cathode) from the sulfur impregnated 3D carbonized carbon nanofiber foam (SCCNF) to obtain the washed sulfur impregnated 3D carbonized carbon nanofiber foam (SCCNF-f-AW). The lithium-sulfur batteries fabricated by using washed sulfur impregnated 3D carbonized carbon nanofiber foam (SCCNF-f-AW) are more stable and exhibit long life.

In an embodiment, after sulfur impregnation and washing steps in the process disclosed herein, the CCNF surface area and pore sizes changes/decreases drastically when SCCNF-f-AW formed i.e., CCNF has surface area ranging from 280 m²g⁻¹ to 350 m²g⁻¹ and pore size below 7 μm (bimodal pore size), and upon sulfur impregnation followed by washing, it gives SCCNF-f-AW with surface area ranging from 20 m²g⁻¹ to 25 m²g⁻¹ and pore size ranging from 2 nm to 5 nm.

In an embodiment, a very high sulfur content of about 50 to 95% is achieved by sulfur impregnation into the CCNF-f. Preferably, the sulfur content is 60-95% or 70 to 95% or 80-95% or 95% is achieved by sulfur impregnation into the CCNF-f.

Still another aspect of the present disclosure relates to a lithium-sulfur cell comprising: (i) a cathode comprising of washed sulfur impregnated 3D carbonized carbon nanofiber foam (SCCNF-f-AW); (ii) an anode; (iii) a separator; and (iv) an electrolyte.

In an embodiment, the washed sulfur impregnated 3D carbonized carbon nanofiber foam (SCCNF-f-AW) exhibits a sulfur loading ranging from 1.2 mgcm⁻² to 1.8 mgcm⁻² in a lithium-sulfur cell. In an embodiment, it exhibits a sulfur loading of 1.5 mgcm⁻² in a lithium-sulfur cell. In an embodiment, the separator comprises a coating of functionalized multi-walled carbon nanotube (f-MWCNT).

In an embodiment, the cathode comprises a washed sulfur impregnated 3D carbonized carbon nanofiber foam (SCCNF-f-AW), carbon black (Super P) and polyvinylidene difluoride (PVDF) in a ratio of 80:10:10 coated onto a carbon-coated aluminium foil.

In an embodiment, the anode is lithium metal. In an embodiment, anode is lithium metal in the form of a disc.

In an embodiment, the separator comprises a functionalized multi-walled carbon nanotube (f-MWCNT). In an embodiment, (f-MWCNT) based separator helps in the retention of battery capacity due to the binding of polysulfides with the functional groups on the MWCNTs. In an embodiment, separator is Celgard 2325 comprising polypropylene-polyethylene-polypropylene (PP/PE/PP) trilayer membrane as separator for lithium battery having a thickness ranging from 20 to 30 micron. In an embodiment, the thickness is about 25 micron.

In an embodiment, the electrolyte comprises of IM Lithium bis(trifluoromethanesulfonyl)imide (LiTFSI) in 1:1 v/v mixture of 1,3-Dioxolane and 1,2-Dimethoxyethane with 0.4 M LiNO₃ as an additive.

In an embodiment, the lithium-sulfur cell comprising: (i) a cathode comprising a washed sulfur impregnated 3D carbonized carbon nanofiber foam (SCCNF-f-AW), carbon black (Super P) and polyvinylidene difluoride (PVDF) in a ratio of 80:10:10 coated onto a carbon-coated aluminium foil; (ii) an anode comprising a lithium metal disc; (iii) a separator comprising PP/PE/PP trilayer membrane having a thickness ranging from 20 to 30 micron; and (iv) an electrolyte comprising 1M LiTFSI in 1:1 v/v mixture of 1,3-Dioxolane and 1,2-Dimethoxyethane with 0.4 M LiNO₃ as an additive.

In an embodiment, the lithium-sulfur cell comprising: (i) a cathode

comprising a washed sulfur impregnated 3D carbonized carbon nanofiber foam (SCCNF-f-AW), carbon black (Super P) and polyvinylidene difluoride (PVDF) in a ratio of 80:10:10 coated onto a carbon-coated aluminium foil; (ii) an anode comprising a lithium metal disc; (iii) a separator comprising PP/PE/PP trilayer membrane coated with the slurry of functionalized multi-walled carbon nanotubes (f-MWCNTs) and PVDF binder (in a ratio of 9:1) in N-Methyl-2-pyrrolidone (NMP); and (iv) an electrolyte comprising 1M LiTFSI in 1:1 v/v mixture of 1,3-Dioxolane and 1,2-Dimethoxyethane with 0.4 M LiNO₃ as an additive.

In an embodiment, the multiwalled carbon nanotubes (MWCNTs) are functionalized by the process comprising; (i) refluxing the MWCNTs with 3M HNO₃ in an oil bath and cooling to room temperature followed by washing with distilled water to neutral pH, (ii) washing the powder of step (i) with absolute ethanol and drying. In an embodiment, the lithium-sulfur cell having washed sulfur impregnated 3D carbonized carbon nanofiber foam (SCCNF-f-AW) and functionalized multi-walled carbon nanotubes (f-MWCNTs) delivers a specific capacity of ˜845 mAhg⁻¹ at 100 mAg⁻¹, exhibiting significant capacity retention in the Li—S cell (SCCNF-f-AW-CNT).

Although the subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter. It is therefore contemplated that such modifications can be made without departing from the spirit or scope of the present subject matter as defined.

### EXAMPLES

### Materials

Carbon nanofibers (SKU: 719803-25G), Resorcinol, Glutaraldehyde, Sodium tetraborate decahydrate, 1,2-Dimethoxyethane (DME), 1,3-Dioxolane (DOL), LiNO₃, Lithium bis(trifluoromethanesulfonyl)imide (LiTFSI), N-Methyl-2-Pyrrolidone, polyvinylidene difluoride (PVDF) were procured from Sigma Aldrich and used without any modification or further purification. Carbon black, Super P was procured from Alfa Aesar. Toluene (Sulfur free) and HNO₃ were procured from Thomas Baker Chemicals Pvt. Ltd. and was used as received. The coin cell (CR-2032) components were procured from Global Nanotech. MWCNT having 10 walls in thickness was procured from Chemapol industries Bombay, India.

### Example 1

### Synthesis of a Washed Sulfur Impregnated 3D Carbonized Carbon Nanofiber Foam (SCCNF-f-AW)

A washed sulfur impregnated 3D carbonized carbon nanofiber foam (SCCNF-f-AW) was synthesized in steps as follow:

### 1. Preparation of Carbon Nanofiber Foam (CNF-f)

The carbon nanofibers were refluxed in 3M HNO₃ at 60° C. for 6 h, followed by washing with a copious amount of de-ionized (DI) water until the pH was neutral. The powder was then washed with absolute ethanol and dried in the oven at 80° C. for 12 h (dried product is termed as ‘f-CNF’ hereafter). The f-CNF and distilled water were taken in a w/v ratio of 5:1 and subjected to ultrasonication for complete dispersion. About 10 μL of glutaraldehyde was added to the dispersion and ultrasonicated for about 15 minutes, followed by the addition of 30 mg of resorcinol and again ultrasonicated for another about 15 minutes. Lastly, 30 mg of sodium tetraborate decahydrate was added into the above solution and ultrasonicated for about 15 minutes. The resulting dispersion was frozen using liquid nitrogen and subjected to vacuum drying (0.120 mbar) at −80° C. to obtain the 3D carbon nanofiber foam (CNF-f).

### 2. Thermal Treatment of 3D Carbon Nanofiber Foam (CNF-f) to Obtain 3D Carbonized CNF Foam (CCNF-f)

The above prepared 3D carbon nanofiber foam (CNF-f) was subjected to thermal treatment at 800° C. at a heating rate of 5° C. per min for 2 h in an inert (Argon gas) atmosphere to convert the cross-linked gel foam into a conducting carbon framework without compromising with the structure thereof. This was found be advantageous to enhance the performance of the Li—S battery through improvement in electronic conductivity. The thermally treated foam samples were collected and labelled as ‘CCNF-f’ (3D carbonized CNF foam).

### 3. Sulfur Impregnation of CCNF-f to Obtain a Sulfur Impregnated 3D Carbonized Carbon Nanofiber Foam (SCCNF-f) and a Washed Sulfur Impregnated 3D Carbonized Carbon Nanofiber (SCCNF-f-AW)

Sulfur impregnation was carried out by placing the CCNF-f in an alumina boat and the CCNF-f was covered completely with fine elemental sulfur powder. The alumina boat was placed inside a tubular furnace and heated to 350° C. at a heating rate of 5° C. per min for 2 h under the continuous flow of argon gas. The set temperature in the furnace was 350° C., but the measured temperature inside the tubular furnace was ˜ 220° C. The sample was collected after the furnace reached room temperature and referred to as sulfur impregnated 3D carbonized carbon nanofiber foam (SCCNF-f).

During the experimentation, it was found that the excessive sulfur was present on the surface of SCCNF-f. Therefore, SCCNF-f was washed with toluene to remove excess sulfur and dried in a vacuum oven at 55° C. for 12 h. The final product was the washed sulfur impregnated 3D carbonized carbon nanofiber foam, labelled as ‘SCCNF-f-AW’. AW indicated ‘after wash’, named so, for carrying out washing of sample after sulfur impregnation.

### Example 2

### Synthesis of Sulfur Impregnated 3D Carbonized CNF Foam Modified With Functionalized Multiwalled Carbon Nanotubes (SCCNF-F-AW-CNT)

The coin cells (battery cells) fabricated using the separator coated with sulfur impregnated 3D carbonized CNF foam (SCCNF-f) modified with functionalized multi-walled carbon nanotubes (SCCNF-f-AW-CNT) was prepared.

### 1. Fictionalization of Multi-Walled Carbon Nanotubes

To functionalize, the multi-walled carbon nanotubes were refluxed in a 3M HNO₃ for 6 h at 60° C. in an oil bath. After cooling down to room temperature, washing was carried out with distilled water till the pH reached neutral. Afterwards, the powder was washed with absolute ethanol and dried in the oven at 80° C. for 12 h. The SCCNF-f-AW-CNT was prepared using the procedure as described in example 1.

### 2. Characterization

Powder X-ray diffraction patterns were recorded on a Phillips PANalytical diffractometer. Raman spectra were carried out on an HR 800 Raman spectrometer (Jobin-Yvon, Horiba, France) using a 632.8 nm red laser. X-ray photoelectron spectroscopic (XPS) measurements were conducted on a VG Micro-Tech ESCA 3000 instrument. The nitrogen adsorption-desorption isotherm measurements were performed on a Quantachrome surface area analyzer; the samples' specific surface areas and pore size distributions were obtained by Brunauer-Emmett-Teller (BET) model and Nonlocal density functional theory (NLDFT). Thermogravimetric analysis was carried out using SDT Q600 DSC-TGA thermogravimetric (TGA) instrument.

3D X-ray microtomography imaging (Xradia 510 Versa X-ray Microscope, Zeiss X-ray Microscopy, Pleasanton, CA, USA) was performed to investigate the morphology, porosity, and pore-size distribution of carbon nanofiber foams. Specimens were loaded onto the sample holder and placed between the X-ray source and the detector assembly. Detector assembly consisted of a scintillator, 20× optics and a CCD camera. X-ray source was ramped up to 80 kV and 7 W. The tomographic image acquisitions were completed by acquiring 7001 projections over 360° of rotation with a pixel size of 0.68 microns for a sample size of 0.7×0.7×0.7 mm3. In addition, projections without the samples in the beam (reference images) were also collected and averaged. The filtered back-projection algorithm reconstructed the projections to generate the two-dimensional (2D) virtual cross-sections of the specimens. Image de-noising, filtration, segmentation, and further processing were performed using the GeoDict software package (GeoDict®, 2018, Math2Market GmBH, Germany). 2D virtual cross-sections were further trimmed down to a sub-volume (100×100×100 voxels with 0.68 cubic microns per voxel), filtered to remove noise and segmented after OTSU threshold selection based on local minima from the grayscale histogram. The resultant 3D reconstructed model was used to estimate the pore characteristics such as porosity, pore-size distribution, etc., using the PoroDict® software package (GeoDict® 2018, Math2Market GmBH, Germany), where pore radius was determined by fitting spheres into the pore volume.

FIG. 1(a) and FIG. 1(b) and illustrates an exemplary snippet depicting powdered X-ray diffraction (p-XRD) patterns of 3D carbonized CNF Foam (CCNF-f) and sulfur impregnated 3D carbonized CNF foam (SCCNF-f-AW). FIG. 1(a) shows typical p-XRD spectrum of CCNF-f with the peaks for (002) and (100) planes appearing at 24.2° and 43°, respectively, corresponding to the partially graphitic nature of the sample. The broadness could be attributed to the cross-linked carbon resulting in amorphous carbonization of the resorcinol-glutaraldehyde linkage. After the impregnation and successive washing the p-XRD confirmed the successful impregnation of sulfur into the foam. As can be seen in FIG. 1(b), diffraction peaks corresponding to sulfur in the SCCNF-f-AW match well with the JCPDS card (#08-0247) for elemental sulfur. The peaks corresponding to CCNF-f could not be observed in the case of SCCNF-f-AW due to the high intensity and dominant diffraction peaks of X-rays from the sulfur compared to carbon.

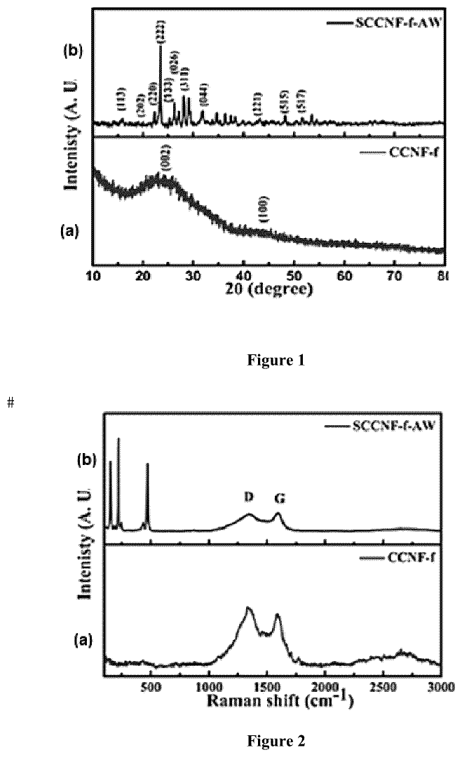

FIG. 2(a) and FIG. 2(b) illustrates an exemplary snippet depicting Raman spectra of CCNF-f and SCCNF-f-AW indicating changes in the intensity and the I_{d}/I_{g} ratio upon conversion of CCNF-f to SCCNF-f-AW. As can be seen in FIG. 2(a), CCNF-f consist of two major peaks corresponding to D and G bands with the slightly higher D band intensity. The high D band intensity indicated the higher defects density of the CCNF-f after carbonization. FIG. 2(b) shows the Raman spectra of SCCNF-f-AW, indicating some high intense peaks centred at 153, 217.6, 433.3, and 471 cm⁻¹ corresponding to the presence of sulfur along with the D and G bands of the host material.

The presence of high-intensity peaks in the p-XRD and the Raman characterization confirmed the successful impregnation of the Sulfur in the host carbon foam.

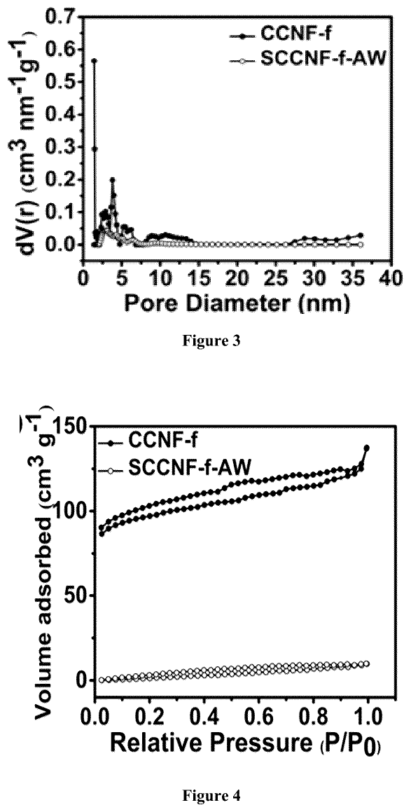

FIG. 3 illustrates an exemplary snippet depicting pore size distribution for CCNF-f) and SCCNF-f-AW using non-local density functional theory (NLDFT). BET analysis was carried out to understand the porous nature of prepared foam materials. BET results were converted to the pore size distribution (PSD) curve shown in FIG. 3 using the NLDFT slit pore model to analyze the porosity distribution. High volume adsorption for CCNF-f, for a pore diameter lesser than 2 nm, indicated the substantial presence of micropores. CCNF-f also consists of the observable presence of mesopores having a diameter range between 2-5 nm and 8 -14 nm. However, SCCNF-f-AW indicated a slight narrower presence of mesopores of the diameter in the 2-5 nm range.

FIG. 4 illustrates an exemplary snippet depicting BET N2 adsorption-desorption isotherm of CCNF-f and SCCNF-f-AW. CCNF-f indicated the presence of type-I and type-IV BET isotherm with a sizeable microporosity and substantial presence of mesopores. However, SCCNF-f-AW consisted of type-IV isotherm only, indicating the only presence of mesopores, thus complimenting the PSD results. MPBET technique was used to estimate the surface area of CCNF-f and SCCNF-f-AW and found to be 310 and 23 m²g⁻¹, respectively.

The results suggested that sulfur impregnation might be blocking the surface pores of SCCNF-f-AW for the N₂ adsorption resulting in the significant reduction of the surface area.

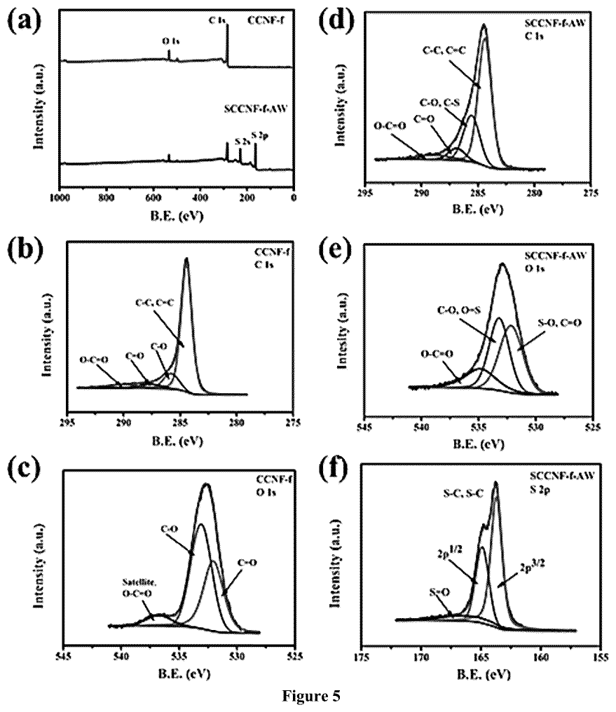

X-ray Photoelectron Spectroscopy (XPS) analysis was performed to analyze the elemental composition and bonding nature at the surface of CCNF-f, SCCNF-f-AW. The resulting spectra are shown in FIG. 5(a) through FIG. 5(f).

FIG. 5(a) represents the survey spectra of CCNF-f, and SCCNF-f-AW, confirming the presence of elemental S in the SCCNF-f-AW samples. FIG. 5(b) and FIG. 5(d) depicts the high-resolution spectra of C1s for the CCNF-f and SCCNF-f-AW samples, respectively. The XPS spectra indicated the presence of C—C & C═C, C—O, C═O, and O—C═O bonds in the CCNF-f. A similar composition was observed for the SCCNF-f-AW except for a significant increase in the peak area around 285.7 eV, which was assigned to the C—O and C—S bonds. The increase in peak area indicated the formation of the C—S bond, which also has a closer B.E. to the C—O bond, and it was difficult to resolve them separately.

FIG. 5(c) and FIG. 5(e) show the high-resolution spectra of O1s for CCNF-f and SCCNF-f-AW, respectively. Both the materials indicate the dominance of presence of C═O, C—O and O—C—O bonds. Moreover, the high-resolution O1s spectra of SCCNF-f-AW contains the additional presence of S—O bonds with binding energy in the range of 532.2 eV, which was the same for C═O. The S—O appears with binding energy in the range of 533.2 eV, which was also in the same range for C—O bond. The binding energy of 534.89 eV corresponds to the presence of O—C═O bonds. The high-resolution spectrum of the Sulfur 2p peak for SCCNF-f-AW is shown in FIG. 5(f). With a peak splitting of 1.13eV, both peaks 2p1/2 and 2p3/2 of Sulfur 2p indicate the significant presence of sulfur in the SCCNF-f-AW.

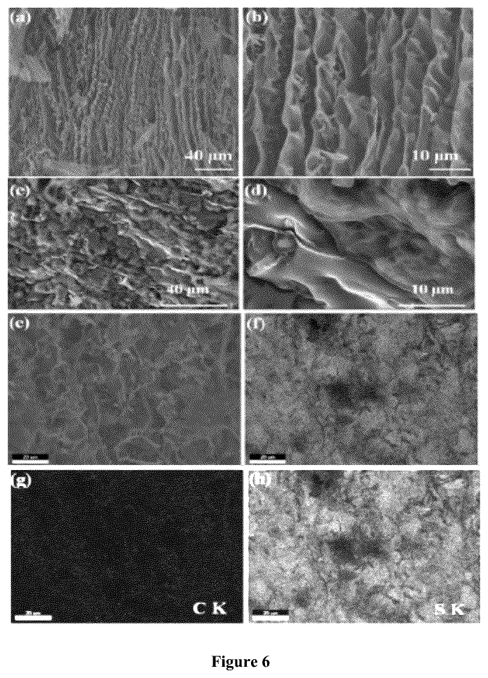

FIG. 6(a) illustrates an exemplary snippet depicting scanning electron micrographs for CCNF-f and SCCNF-f-AW. FIG. 6(a) and FIG. 6(b) indicate that CCNF-f consists of a 3D interconnected structure of carbon nanofibers formed by polymerization between the f-CNF using resorcinol and glutaraldehyde cross-linker. FIG. 6(c) and FIG. 6(d) shows the FESEM images of SCCNF-f-AW after sulfur impregnation in CCNF-f and washing with toluene. The SEM image confirmed that pore of the CCNF-f are filled with the impregnated sulfur whilst retaining the 3D network. The elemental mapping of the SCCNF-f-AW is shown in FIG. 6(e) through FIG. 6(h). FIG. 6(e) shows the SEM image and the overlay image FIG. 6(f) shows the presence of carbon and sulfur in the samples. FIG. 6 (g) and FIG. 6(h) shows the distribution of carbon and sulfur in the 3D foam. The pores of the CCNF-f are filled with the impregnated sulfur, as was evident from the elemental mapping.

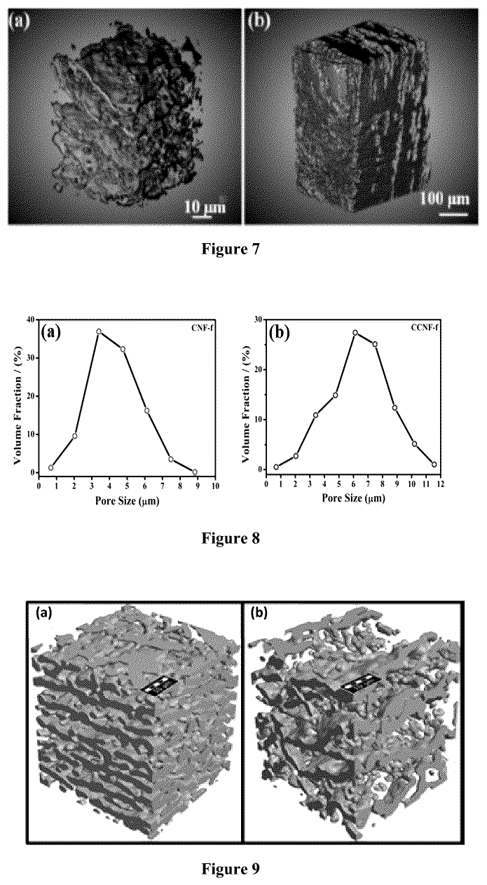

FIG. 7(a) and FIG. 7(b) illustrates an exemplary snippet depicting 3D volume rendered X-ray tomography of CCNF-f and SCCNF-f-AW. FIG. 7A shows the 3D porous arrangement of CCNF-f, which retains its interconnecting stacked layers after the carbonization at 800° C. The structure of CCNF-f also exhibits an enhancement in the porosity of the foam after carbonization. The prepared CNF-f was found to have a porosity of 70%, which further increased to 80% for CCNF-f due to the shrinkage of the interlinking carbon network as a result of thermal treatment. FIG. 7(b) exhibits a volume-rendered tomography image of SCCNF-f-AW to map the presence of impregnated S in the host. A very high sulfur loading was observable without disturbing the CCNF-f structure after impregnation.

FIG. 8(a) and FIG. 8(b) illustrates an exemplary snippet depicting pore size distribution obtained from tomography analysis for CNF-f and CCNF-f. The pore size distribution observed in microtomography analysis was in the micrometer size as the instrument's true spatial resolution limit was 1 μm. As can be seen in FIG. 8(a), pores in CNF-f had an average pore size of around 4 μm, which further increased to about approximately ˜7 μm for CCNF-f (as can be seen in FIG. 8(b) after the thermal treatment.

FIG. 9(a) and FIG. 9(b) illustrates an exemplary snippet depicting segmented 3D X-ray tomography of CNF-f and CCNF-f respectively.

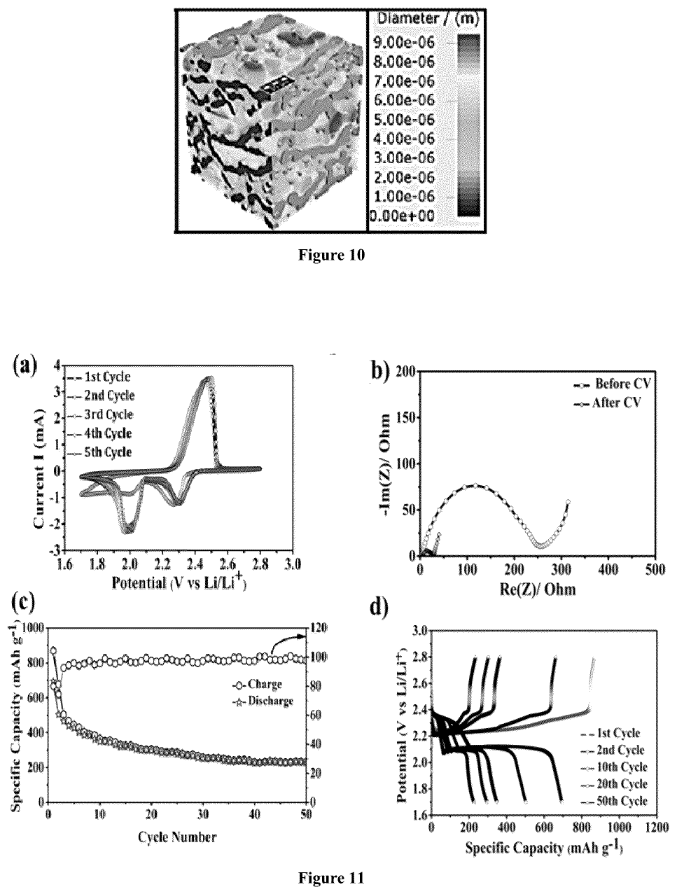

FIG. 10 illustrates an exemplary snippet depicting 3D visualization of pores in CCNF-f.

The BET results of CCNF-f show a collective porosity distribution in the micro-mesoporous range (nano regime). At the same time, computational tomography estimation provides a porosity distribution in micro regime with 7-micron pore contributing to maximum volume fraction for CCNF-f. From the results it can be established that the CCNF-f foam has a bimodal porosity distribution in the micro and nano regime, making it as an ideal host candidate for high sulfur loading as observed in TGA analysis.

FIG. 11 illustrates exemplary snippets depicting (a) Cyclic voltammogram (CV) at a scan rate of 0.1 mV s⁻¹, (b) Electrochemical impedance spectra before and after the CV measurement, (c) cycling stability at a current density of 100 mAg⁻¹ and (d) specific capacity versus potential graph for the sample SCCNF-f-AW. The Coin cells of SCCNF-f-AW were assembled with the composition of 80:10:10 ratio of the SCCNF-f-AW:PVDF: conducting carbon.

FIG. 11(a) shows the cyclic voltammogram recorded at a scan rate of 0.1 mV s⁻¹. The cyclic voltammogram exhibits characteristic peaks corresponding to the typical Li—S electrochemical behaviour with reversible reduction and oxidation processes. The reduction process occurred in two steps, with the first peak appearing ˜2.3 V due to the reduction of S₈ to long-chain polysulfides (Li₂Sₙ, 4≤n≤8) at high potential and the peak at ˜2.0 V appeared due to further reduction of long-chain polysulfides to short-chain polysulfides (Li₂Sₙ, 1≤n<4). The oxidation peak associated with the reversible formation of short-chain polysulfides to long-chain polysulfides and then to S8 was observed at 2.46 V. Except for the first cycle, the following cycles overlap, exhibiting excellent electrochemical reversibility.

FIG. 11(b) shows the impedance spectroscopic measurements before and after the CV. The cell showed a series resistance of 3.2Ω and charge transfer resistance of 231Ω, after the CV, the series resistance was ˜5.4Ω, and the charge-transfer resistance was reduced to ˜18.8Ω.

FIG. 11(c) shows the cycling data at a current density of 100 mA g⁻¹, delivered an initial discharge capacity of ˜694 mAh g⁻¹ and decreased to 228 mAh g⁻¹ after 50 cycles.

FIG. 11(d) shows the plot of specific capacity vs potential, which displays two distinct charge-discharge plateaus associated with the oxidation-reduction reactions between Li and S, which was found to be a characteristic feature of the Li—S battery. These plateaus matched well with the redox peaks that appeared in the CV curves. The formation of soluble long-chain lithium polysulfides was recognized by the appearance of a discharge plateau at a higher potential. The discharge plateau at lower potential was ascribed to the reduction of long-chain polysulfides to short-chain polysulfides.

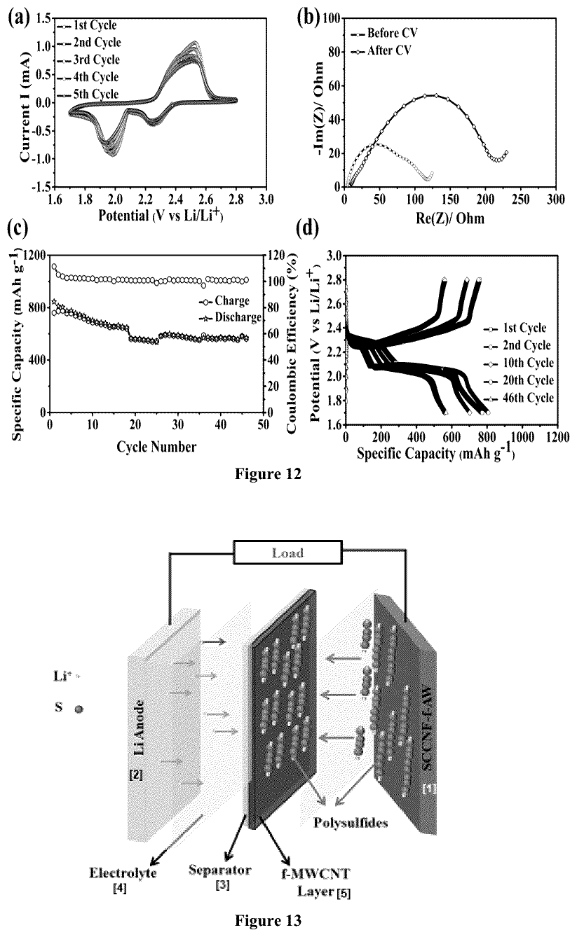

FIG. 12(a) through FIG. 12(d) illustrates exemplary snippets depicting (a) Cyclic voltammogram (CV) at a scan rate of 0.05 mV s⁻¹, (b) Electrochemical impedance spectra before and after the CV measurement, (c) cycling stability at a current density of 100 mAg⁻¹ and (d) rate capability data for the sample SCCNF-f-AW-CNT. The preparation followed the following steps:

### Modifying Separator With MWCNTs in the Coin Cell

Modifying separator with MWCNTs helped in the retention of capacity due to the binding of polysulfides with the functional groups on the MWCNTs. In the present invention, to improve capacity retention and to mitigate the polysulfide dissolution the separator was further modified with functionalized multi-walled carbon nanotubes (f-MWCNT).

### 3. Preparation of Functionalized Multi-Walled Carbon Nanotubes

To functionalize, the multi-walled carbon nanotubes were refluxed in a 3M HNO₃ for 6 h at 60° C. in an oil bath. After cooling down to room temperature, washing was carried out with de-ionized water till the pH reached neutral. Afterwards, the powder was washed with absolute ethanol and dried in the oven at 80° C. for 12 h.

### Electrochemical Study of Li—S Coin Cell With Modified Separator

The f-MWCNTs were coated on the separator by making slurry of f-MWCNTs and PVDF binder (9:1) in NMP. The cells were fabricated such that the f-MWCNT coated side of the separator faces the cathode. The electrochemical results with modified separator are shown in FIG. 12(a) through FIG. 12(d).

FIG. 12(a) shows the CV carried out at a scan rate of 0.05 mV s⁻¹ exhibited two distinct reduction peaks, the first peak at 2.25 V corresponded to the formation of long-chain polysulfides Li₂Sₙ, (4≤n≤8) and the second peak at ˜2.0 V to the further reduction of long-chain polysulfides to the short-chain Li₂S₂/Li₂S. The oxidation peak at 2.5 V was attributed to the formation of long-chain polysulfides from the short-chain polysulfides and then to form the S₈.

FIG. 12(b) shows the impedance spectrum before and after the CV measurements. The series resistance of the cell was ˜3.6Ω, and it increased to 15.8Ω after 5 cycles. The charge-transfer resistance before CV was ˜81 Ω which increased to ˜206Ω after cycling. The decrease in charge transfer resistance of the cell using MWCNTs separator was noted. This increase in series resistance and charge-transfer resistance after cycling was attributed to the trapping of polysulfides by the MWCNT coating on the separator.

FIG. 12(c) shows the cycling data at a current density of 100 mA g⁻¹; first and second cycles were cycled at a current density of 10 mAg⁻¹ and 25 mAg⁻¹, respectively and further cycling was continued at 100 mAg⁻¹. An initial discharge capacity of ˜845 mAhg⁻¹ was achieved and decreased to ˜567 mAhg⁻¹ after 46 cycles, with significant improvement in the capacity retention as a result of separator modification.

FIG. 12(d) depicts the plot of specific capacity vs potential showing two distinct plateaus in the discharge curves corresponding to the reduction of S8 to Li₂Sₙ (4≤n≤8) and then to Li₂S₂/Li₂S. These short-chain polysulfides were further converted to long-chain polysulfides and then to Sulfur during the charging process.

The separator modification improved the specific capacity and stability by reducing the polysulfide shuttling through the binding of polysulfides to the functional groups (such as —COOH, —OH) present on the MWCNT surface.

Although the subject matter has been described herein with reference to certain preferred embodiments thereof, other embodiments are possible. As such, the spirit and scope of the appended claims should not be limited to the description of the preferred embodiment contained therein. Furthermore, precise and systematic details on all above aspects are currently being made. Work is still underway on this invention. It will be obvious to those skilled in the art to make various changes, modifications and alterations to the invention described herein. To the extent that these various changes, modifications and alterations do not depart from the scope of the present invention, they are intended to be encompassed therein.

### ADVANTAGES OF THE INVENTION

(i) The present disclosure overcomes one or more drawbacks associated with the conventional carbon-based host in Li-sulfur battery and methods of preparation thereof.

The present disclosure provides washed sulfur impregnated 3D carbonized carbon nanofiber foam (SCCNF-F-AW) for lithium-sulfur battery.

The present disclosure provides washed sulfur impregnated 3D carbonized carbon nanofiber foam (SCCNF-f-AW) that acts as a cathode in lithium-sulfur battery.

The present disclosure provides washed sulfur impregnated 3D carbonized carbon nanofiber foam (SCCNF-f-AW) exhibiting high sulfur loading capacity in lithium-sulfur battery.

The present disclosure provides washed sulfur impregnated 3D carbonized carbon nanofiber foam (SCCNF-f-AW) that is stable and gives a long life to Li—S batteries.

The present disclosure provides a method of preparation of a washed sulfur impregnated 3D carbonized carbon nanofiber foam (SCCNF-f-AW) for a lithium-sulfur battery that is easy and economical.

The present disclosure provides a lithium-sulfur cell comprising said washed sulfur impregnated 3D carbonized carbon nanofiber foam (SCCNF-f-AW) as a cathode.

1. A composite comprising a solvent-washed sulfur impregnated 3D carbonized carbon nanofiber foam (SCCNF-f-AW) for lithium-sulfur battery, having surface area ranging from 20 m²g⁻¹ to 25 m²g⁻¹ and pore size ranging from 2 nm to 5 nm.

2. The composite as claimed in claim 1, wherein the solvent-washed sulfur impregnated 3D carbonized carbon nanofiber foam (SCCNF-f-AW) has surface area of 23 m²g⁻¹ and pores size ranging from 2 nm to 5 nm.

3. A process for preparation of a solvent-washed sulfur impregnated 3D carbonized carbon nanofiber foam (SCCNF-f-AW) for lithium-sulfur battery, the process comprising the steps of:
(i) taking a carbon nanofiber powder (CNF) and refluxing it with HNO₃ to obtain a carbon nanofiber (CNF) powder;
(ii) washing the carbon nanofiber (CNF) powder obtained in step (i) with de-ionized water and ethanol and dried to obtain a functionalized carbon nanofiber foam (f-CNF);
(iii) dispersing the functionalized carbon nanofiber foam (f-CNF) in de-ionized water in a ratio ranging from 4:1 to 6:1 and subjected to ultrasonication for dispersion;
(iv) adding glutaraldehyde, resorcinol, and sodium tetraborate decahydrate to the above obtained ultrasonicated mixture of step (iii);
(v) subjecting the mixture obtained in step (iv) to freezing and drying to obtain a 3D carbon nanofiber foam (CNF-f);
(vi) subjecting the 3D carbon nanofiber foam (CNF-f) to a thermal treatment to obtain a 3D carbonized carbon nanofiber foam (CCNF-f);
(vii) impregnating the 3D carbonized carbon nanofiber foam (CCNF-f) obtained in step (vi) with sulfur by heating the CCNF-f with an elemental sulfur powder to obtain a sulfur impregnated 3D carbonized carbon nanofiber foam (SCCNF-f); and
(viii) subjecting the sulfur impregnated 3D carbonized carbon nanofiber foam (SCCNF-f) obtained in step (vii) to washing with a solvent to remove excess sulfur to obtain the solvent-washed sulfur impregnated 3D carbonized carbon nanofiber foam (SCCNF-f-AW).

4. The process as claimed in claim 3, wherein the carbon nanofiber (CNF) is refluxed with HNO₃ in step (i) at a temperature ranging from 50° C. to 70° C. for a time period ranging from 4 hr to 10 hr, and wherein the impregnation in step (vii) is performed at a temperature ranging from 160° C. to 250° C. for a time period ranging from 1 hr to 3 hr.

5. The process as claimed in claim 3, wherein the functionalized carbon nanofiber foam (f-CNF) is dispersed in distilled water in step (iii) in a ratio of 5:1.

6. The process as claimed in claim 3, wherein the 3D carbon nanofiber foam (CNF-f) in step (vi) is subjected to thermal treatment at a temperature from 700° C. to 900° C., and more preferably, the 3D carbon nanofiber foam (CNF-f) in step (vi) is subjected to thermal treatment at a temperature of 800° C.

7. The process as claimed in claim 3, wherein the solvent is selected from any or a combination of chlorobenzene, toluene, p-xylene, and cyclohexane.

8. A lithium-sulfur cell comprising:
(i) a cathode comprising a solvent-washed sulfur impregnated 3D carbonized carbon nanofiber foam (SCCNF-f-AW);
(ii) an anode;
(iii) a separator; and
(iv) an electrolyte.

9. The lithium-sulfur cell as claimed in 8, wherein the solvent-washed sulfur impregnated 3D carbonized carbon nanofiber foam (SCCNF-f-AW) exhibits sulfur loading ranging from 1.2 mgcm⁻² to 1.8 mgcm⁻².

10. The lithium-sulfur cell as claimed in 8, wherein the separator comprises a coating of functionalized multi-walled carbon nanotube (f-MWCNT).
